(19) United States
(12) Patent Application Publication
(10) Pub. No.: US 2016/0053425 A1
(43) Pub. Date: Feb. 25, 2016

(54) WATER TREATMENT SYSTEM

(71) Applicant: HYDRASYST IP PTY LTD, Ashmore (AU)

(72) Inventor: Kyle Anthony WOLFF, Ashmore (AU)

(21) Appl. No.: 14/778,599

(22) PCT Filed: Mar. 18, 2014
(86) PCT No.: PCT/AU2014/000288

§ 371 Date: Sep. 20, 2015

Related U.S. Application Data
(60) Provisional application No. 61/803,566, filed on Mar. 20, 2013.

(51) Int. Cl. D06F 39/00; C02F 1/32; C02F 1/66; C02F 9/00; C02F 1/28; D06F 39/10; B01D 61/14; B01D 61/58; B01D 65/02; B01D 71/02; D06F 31/00; C02F 1/44; B01D 61/02

(52) U.S. Cl. CPC D06F 39/006; C02F 1/444; C02F 1/442; C02F 1/441; C02F 1/325; C02F 1/66; C02F 9/00; C02F 1/283; B01D 61/025; B01D 61/027; B01D 61/145; B01D 61/147; B01D 61/58; B01D 65/02; B01D 71/02; D06F 31/005; D06F 39/10; C02F 2103/002

(57) ABSTRACT

This invention relates in general to a water treatment system and process for a continuous batch or “tunnel” washing machines. The water treatment system comprising; a continuous batch laundry system comprising a plurality of longitudinally aligned modules having inlet means at one end for receiving articles to be laundered and a discharge means at the other end, each said module including a rotatably supported drum within a housing, said drum being supported for oscillatory and rotary movement about a horizontal axis, wherein each drum includes spaced end walls, each end wall of each drum including a large opening to provide communication between adjacent drums, inlet flow lines on each module to allow chemicals and water into each module and outlet flow lines located on each module for draining each module, and a driving means for inducing rotation and oscillation in at least a selected one of said drums; a filtering apparatus connected between the outlet flow lines and the inlet flow lines of the continuous batch laundry system to filter and reclaim a mixture of water and chemicals drained from each module the filtering apparatus comprising: a filter; a flow apparatus operable to pass the mixture of water and chemicals through the filter in a forward direction so as to filter the water and chemicals: a heater operatively able to heat the mixture that pass through the filter; and a temperature controller operatively associated with the heater to control a temperature of the mixture within a preconfigured temperature range; wherein the filtered and reclaimed mixture of water and chemicals is fed from the filtering apparatus and into the inlet flow lines of each said module of the continuous batch laundry system as required.

### FIELD OF THE INVENTION

This invention relates in general to a water treatment system and process for a continuous batch or “tunnel” washing machines. In particular, the present invention relates to a system and process for the reclamation and reuse of waste-water effluent, energy and chemical recovery from a continuous batch or “tunnel” washing machines in laundry operations.

### BACKGROUND OF THE INVENTION

It should be noted that reference to the prior art herein is not to be taken as an acknowledgement that such prior art constitutes common general knowledge in the art.

Certain batch laundry systems are well known in the art and are utilized extensively in commercial laundry applications and in the treatment or washing of textile piece goods. Typically known batch laundry machines include a longitudinally elongated housing which encloses a plurality of chambers which are utilized for prewash, rinse, main wash, boiling or cold rinsing, and other forms of treatment. Generally water is circulated through the machines and recycled from the outlet end back to the inlet end. Drive means are generally provided for oscillating the various chambers to maximize the cleansing action.

Well known batch laundry systems exist which utilize a drum or cylinder which includes a transfer chute which acts to retain the contents of the cylinder during oscillation and serves to transfer the contents to an adjacent cylinder upon unidirectional rotation of that cylinder. Thus, the contents of such a system enter the system at one end and proceed through the various cylinders to exit.

Normally, water usage typically in tunnel washers results in its contamination and the resulting waste water is no longer useful for most applications. Therefore, waters from domestic and industrial users have been the subject of treatment and purification for a long time in order to remove toxic contaminants, bad odors and suspended solids. The recycling, reuse or reticulation of water is increasingly important in making economical use of clean water supplies and in minimising pollution.

Water recycling is a common application in industrial laundries and in particular in the tunnel washers. The water from batch laundry systems generally carries contaminants such as dirt, mud, sand, fibre, detergents, phosphates, salts, organic chemicals and organic materials such as pathogens, bacteria, and virus from human or animal contact.

Recycling water presents particular problems. One problem is obtaining maximum recycle rates or rates which are high enough to justify the cost and/or space and energy used by the recycling apparatus. Another problem is the variety and levels of materials and contaminants that need to be removed from water before it can be reused or recycled. Combined with the first problem, this presents a significant challenge. Other problems relate to water recycling systems often needing to be on-site where maintenance staff are often not on hand to provide maintenance of the system.

One approach to recycling water in general, but grey water specifically uses a ceramic membrane, such as a membrane made of a Al₂O₃ or silicon carbide ceramic to filter-water. These types of filter can remove a wide range of contaminant. However, apparatuses taking this approach often require a large footprint. Also, they can suffer limitations in flux per square metre of membrane, particularly over extended periods of use. Other limitations arise in maintaining consistent flow through the ceramic membrane, particularly in grey water recycling and maintenance or lifetime of the ceramic membranes. In practical applications, this can result in limited recycling efficiency and yield. Other limitations relate to energy consumption due to the mechanical structure of the membrane.

Another issue which is becoming more prevalent with today's environmental issues is the use of chemicals in the batch or tunnel laundry systems. The uses of chemicals are essential for washing and are added at every stage of the washing process. These chemicals include alkalies which increase the pH to facilitate the break-down of proteins and acids such as phosphoric and citric are used to neutralise the alkaline pH. Surfactants are also used and range from non-ionic, anionic and cationic surfactants. The non ionic and anionic surfactants increase the soil removal capabilities and cationic surfactants are applied as fabric softeners. Builders such as phosphate and chelating agents inactivate hardness minerals and thereby increase the cleaning efficiency of the surfactants. Finally, bleaching chemicals such as hypochlorite, peroxides perborates and percarbonates are also used in tunnel laundry and any commercial laundry facilities.

It is therefore important to reduce the amount of usage of these chemicals and provide a means of reclaiming the chemicals from the waste water to be reused in the washing process.

Clearly it would be advantageous if a water treatment system could be devised that helped to at least ameliorate some of the shortcomings described above. In particular, it would be beneficial for a water treatment system to improve on these deficiencies in water treatment techniques, or to at least provide a useful alternative.

### SUMMARY OF THE INVENTION

In accordance with a first aspect, the present invention provides a water treatment system comprising: a continuous batch laundry system comprising a plurality of longitudinally aligned modules having inlet means at one end for receiving articles to be laundered and a discharge means at the other end, each said module including a rotatably supported drum within a housing, said drum being supported for oscillatory and rotary movement about a horizontal axis, wherein each drum includes spaced end walls, each end wall of each drum including a large opening to provide communication between adjacent drums, inlet flow lines on each module to allow chemicals and water into each module and outlet flow lines located on each module for draining each module, and a driving means for inducing rotation and oscillation in at least a selected one of said drums; a filtering apparatus connected between the outlet flow lines and the inlet flow lines of the continuous batch laundry system to filter and reclaim a mixture of water and chemicals drained from each module the filtering apparatus comprising: a filter; a flow apparatus operable to pass the mixture of water and chemicals through the filter in a forward direction so as to filter the water and chemicals; a heater operatively able to heat the mixture that pass through the filter; and a temperature controller operatively associated with the heater to control a temperature of the mixture within a preconfigured temperature range; wherein the filtered and reclaimed mixture of water and chemicals is fed from the filtering apparatus and into the inlet flow lines of each said module of the continuous batch laundry system as required.

Preferably, the temperature controller may be configured to control the temperature of the mixture of water and chemicals between 40 degrees Celsius and 90 degrees Celsius.

Preferably, the flow apparatus may pass water through the filter at a pressure between 1 and 3 bar and at a rate at the filter surface between 1 and 3 metres per second. The flow apparatus may include forward-flow apparatus operable to provide the forward-flow and reverse-flow apparatus operable to provide the reverse flow. The reverse-flow apparatus may include a backwash pump and tank operable to receive filtered water from the filter to provide water to the reverse-flow apparatus.

Preferably, the reverse-flow apparatus may include: a back-wash pump and tank which is operable to be pressurised; pressure apparatus operable to pressurise the tank; and a backwash conduit connected to the filter such that when the backwash tank is pressurised, water from the backwash tank is provided to the filter in the reverse direction.

Preferably, the filter may comprise a media filter or a membrane filter, the membrane filter adapted to provide both microfiltration and ultrafiltration. The microfiltration or the ultrafiltration filters may be used as pre-filters for any one of or combination of: (i) a nanofiltration filter; or (ii) a reverse osmosis filter.

Preferably, the membrane filter comprises any one of or combination of: (i) a ceramic membrane filter; (ii) a ceramic hollow fibre membrane filter; (iii) a channel ceramic membrane filter; or (iv) a silicon carbide ceramic membrane filter.

Preferably the system may further include a preliminary filter to filter water prior to it being passed through the membrane filter, the preliminary filter comprising a vibrating membrane.

Preferably, the system may further include a carbon filter downstream of the membrane filter.

Preferably, the system may further include a UV treatment apparatus downstream of the membrane filter to treat water with Ultra Violet light to disinfect the water.

Preferably, the system may further include a pH adjustment apparatus operable to adjust the pH level of filtered water. The pH level may be maintained between 6 and 8.

Preferably, the continuous batch laundry system may be a continuous batch tunnel washer.

In accordance with a further aspect, the present invention provides a process to treat a mixture of water and chemicals including: providing a continuous batch laundry system comprising a plurality of longitudinally aligned modules; providing a filtering apparatus to filter and reclaim the mixture of water and chemicals drained from each module; providing a flow apparatus for passing the mixture through the filter in a forward direction so as to filter the mixture; providing, a heater operatively able to heat the mixture that pass through the filter; and a temperature controller operatively associated with the heater to control the temperature of the mixture within a preconfigured temperature range prior to passing the mixture through the filter.

Preferably, the process may be used to control the system of any one of the features of the first aspect.

Preferably, the process may be controlled by a computer comprising: a code memory operable to store processor executable code; a processor operable to execute code stored in the code memory; and a data memory operable to store data, wherein the code memory stores the code which when executed causes the processor to control the system of any one of the features of the first aspect.

In accordance with a still further aspect, the present invention provides a process for reducing water, chemical and energy consumption in a continuous batch laundry system wherein a mixture of waste water and chemicals is produced as a result of mixing all water from a wash cycle and all water from a rinse cycle of the continuous batch laundry system operating at a predetermined operating wash temperature, comprising the following steps: (a) processing the mixture of said waste water and chemicals to separate therefrom lint and suspended particles greater than a predetermined size and to produce a corresponding portion of processed water and chemicals; (b) heating the processed water and chemicals to a predetermined temperature; (c) passing the heated and processed water and chemicals through a filer; (d) returning the heated and processed mixture of water and chemicals to the continuous batch laundry system as required; (e) carrying out said wash cycle of the continuous batch laundry system utilizing said returned mixture of water and chemicals; and (f) providing unheated fresh water to the washing equipment during a rinsing cycle and/or a starch cycle thereof.

Preferably, the step of filtration may be carried out by passing said mixture of said waste water and chemicals through at least one tubular filtration unit. The at least one tubular filtration unit may comprise at least one tubular membrane filter capable of retaining particles larger than approximately 5 micron.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 shows a schematic diagram of a water treatment system for a tunnel washer in accordance with an embodiment of the present invention;

FIG. 2 shows a schematic diagram, of the water recycling apparatus of FIG. 1;

FIG. 3 illustrates a tunnel washer of FIG. 1; and

FIG. 4 is a block diagram of a control system to control operation of the water recycling apparatus of FIG. 2.

### DETAILED DESCRIPTION OF THE PREFERRED EMBODIMENTS

The following description, given by way of example only, is described in order to provide a more precise understanding of the subject matter of a preferred embodiment or embodiments.

Described embodiments relate generally to methods, systems and apparatus for a water treatment system and computer readable storage configured to control the performance of such methods, systems and apparatus. The water treatment system is typically used for the treatment of water used in such activities as in a laundry for example, and the described embodiments are particularly suited to such purposes. For example, embodiments may be used as part of a larger industrial water usage process, such as for laundering laundry articles, where high throughput of water is required. Embodiments are not, however, limited to such use.

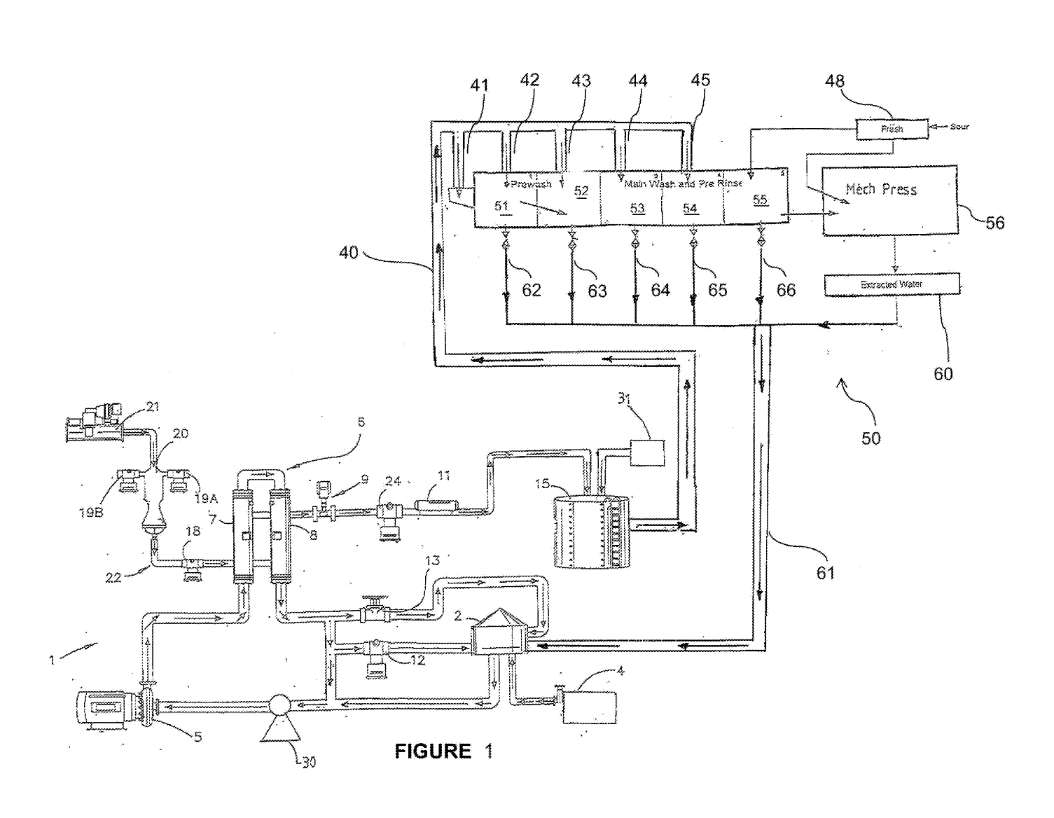

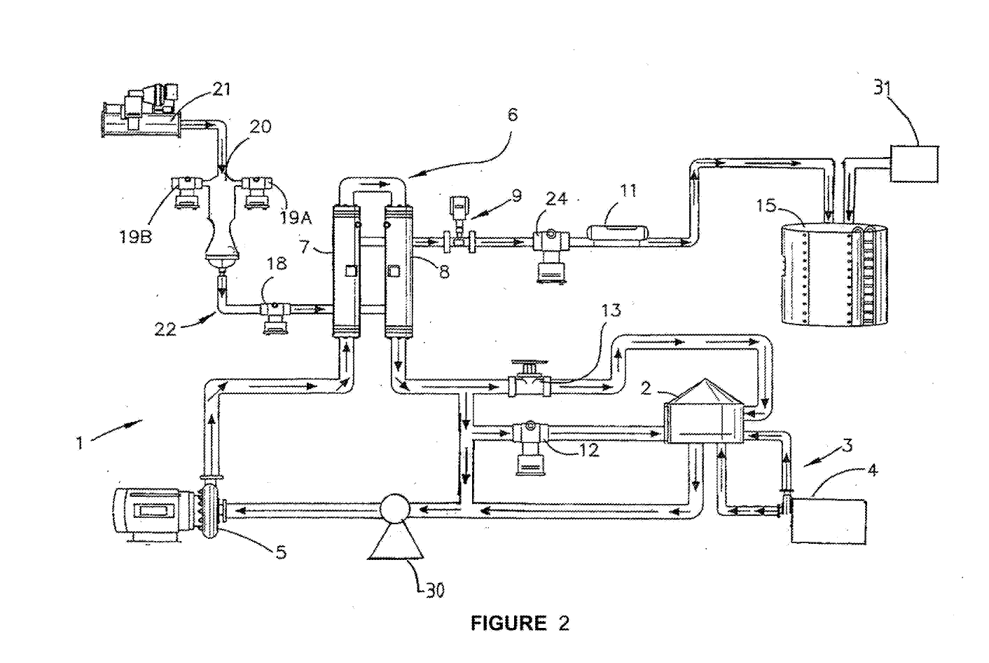

With reference to FIG. 1, there is depicted a schematic diagram of the water treatment system which includes the continuous batch laundry system 50 and the water treatment apparatus 1 of the present invention. As can be seen, system 50 includes a plurality of longitudinally aligned modules 51, 52, 53, 54 and 55 each of which houses a rotatably supported drum. Also shown in FIGS. 1 and 2 is the water treatment and recycling apparatus 1 which includes a raw water tank 2 and a permeate tank 15.

A temperature controller 4, for example in the form of a Direct Steam Injection (DSI) device and pump may draw off and returns water from the raw water tank 2 to maintain the water at a temperature above 40 degrees. The pump may be a centrifugal pump able to draw water though the direct steam injection device and back into the raw water tank 2. Suitable DSI or other heating devices and pumps can be used for this function, including thermostatic mixing valves. As a further arrangement the temperature controller 4 may also control the temperature of the fresh or mains water using either a direct steam injection device or a thermostatic mixing valve.

The temperature may be maintained by the temperature controller 4 at 60 degrees Celsius which is 20 degrees above the lowest temperature of water used by the commercial laundry for which water is recycled. This temperature provides improved efficiency of ceramic membranes 6 used in the apparatus but involves minimal energy wastage as water is heated only 20 degrees above that required by the commercial laundry for its lowest temperature operation cycle. The improved efficiency of the ceramic membrane 6 results in improved filtration and a higher percentage of the raw water being recycled. Alternative embodiments may use alternatives to direct steam injection or thermostatic mixing valves for temperature control.

The raw water tank 2 feeds a booster pump 5 via a transfer pump 30. The booster pump 5 supplies water at pressure to a ceramic membrane filter 6 formed by two or more membrane vessels 7 and 8 connected in series. The raw water tank 2 receives the raw water drained from the continuous batch laundry system 50 via pipes 61, 62, 63, 64, 65, 66 and also the extracted water 60 from the mechanical press 56. The raw water drained from the continuous batch laundry system 50 includes chemicals such as alkalies, acids used to neutralise the alkaline pH, surfactants, builders such as phosphate and chelating, agents, and bleaching chemicals such as hypochlorite, peroxides perborates and percarbonates.

In this embodiment the membranes used in the ceramic membrane filter 6 is selected to have average membrane apertures of 0.1 mircometres. Other suitable membrane apertures will be apparent to the reader. Likewise other types of membrane filters may be used either alone or in combination with the ceramic membrane filter such as a ceramic hollow fibre membrane filter; a channel ceramic membrane filter; or a silicon carbide ceramic membrane filter.

The ceramic hollow fibre membranes range from 20 nanometers (nm) through to 1400 nm, depending on feed water quality. Ceramic materials are generally very stable chemically, thermally and mechanically, and in addition are frequently bio inert and are ideally used in such applications as water and wastewater processing. For the channel ceramic membrane filters the waste water flows through the channels of the membrane carrier and filtered dependent upon particle size. Silicon carbide is a durable manmade membrane filter with high flux and high permeability while using a cross-flow filtration process ensures the continuous removal of contaminant from the membrane surface.

In a further embodiment the ceramic membrane filter may be replaced with a media filter or may be used in conjunction with a media filter. A media filter is taken to mean any type of filter that uses some form of media such as a bed of sand, crushed granite or other material to filter water for use in the continuous batch laundry system 50.

The membrane filter is adapted to provide both microfiltration and ultrafiltration. Microfiltration is a membrane technical filtration process which removes contaminants from a fluid (liquid & gas) by passage through a microporous membrane. A typical microfiltration membrane pore size range is 0.1 to 10 micrometres (μm). Ultrafiltration is typically a variety of membrane filtration in which hydrostatic pressure forces a liquid against a semipermeable membrane. Suspended solids and solutes of high molecular weight are retained, while water and low molecular weight solutes pass through the membrane.

The microfiltration or the ultrafiltration filters may be used as pre-filters for any one of or combination of: (i) a nanofiltration filter; or (ii) a reverse osmosis filter.

Nanofiltration is a relatively recent membrane filtration process used most often with low total dissolved solids water such as the water from the continuous batch laundry system 50, with the purpose of softening (polyvalent cation removal) and removal of disinfection by-product precursors such as natural organic flatter and synthetic organic matter. Reverse osmosis is a membrane-technology filtration method that removes many types of large molecules and ions from solutions by applying pressure to the solution when it is on one side of a selective membrane. The result is that the solute is retained on the pressurized side of the membrane and the pure solvent is allowed to pass to the other side. To be “selective,” this membrane should not allow large molecules or ions through the pores (holes), but should allow smaller components of the solution (such as the solvent) to pass freely.

Microfiltration is fundamentally different from reverse osmosis and nanofiltration because those systems use pressure as a means of forcing water to go from low pressure to high pressure. Microfiltration can use a pressurized system but it does not need to include pressure.

Another embodiment may use an aperture size of 0.2 micrometres. Also in this embodiment the ceramic membrane filter 6 and pump are selected, to cause 5000 litres of water per hour to be forced, or permeate, through the ceramic membrane at a surface rate of between 2 and 7 metres per second. In this specific embodiment, the rate of 2.35 metres per second has been selected. In other embodiments this rate is not selected so precisely as +/−0.05 metres per second. The ceramic membrane filter of this embodiment is a type with hollow ceramic fibres, such as INOCEP™ ceramic hollow fiber membranes. A flow meter 9 after the ceramic membranes filter 6 measures the flow through the membrane. The apparatus has a permeate solenoid valve 24 connected to the flow meter 9 to control flow of the filtered water.

An Ultra Violet (UV) disinfection device 11 may be connected after (i.e. downstream of) the permeate solenoid valve 24. In embodiments configured to recycle 5000 litres per hour of water for commercial laundry use, the UV disinfection apparatus may have 2 or 4 1000 mm amalgam lamps (not shown). These lamps can generally tolerate water temperatures up to 90 degrees Celsius. Amalgam lamps also typically have a high operational lifetime, of up to 16000 hours. Additionally, amalgam lamps have been observed by the applicant to have a higher disinfection effectiveness than some alternative standard UV lamps.

In a further embodiment an activated carbon tank is connected to the UV disinfection apparatus 11. In the carbon tank, the permeate is in, contact with coal-based steam activated carbon meshes in unwashed granular form. The meshes of this embodiment measure 12×40 mm. The amount of carbon in the tank is chosen for the flow rate of the apparatus and the water quality required. The tank, of this embodiment is configured to provide between 6 and 12 minutes of contact for the water with the activated carbon. Contact with the activated carbon absorbs non-ionic surfactants, odours and any other small contaminants that may be left in the permeate water after filtration by the ceramic membrane filter. Suitable dimensions and amounts of material as well as types of material for given specific applications will be apparent to the person of ordinary skill in the art.

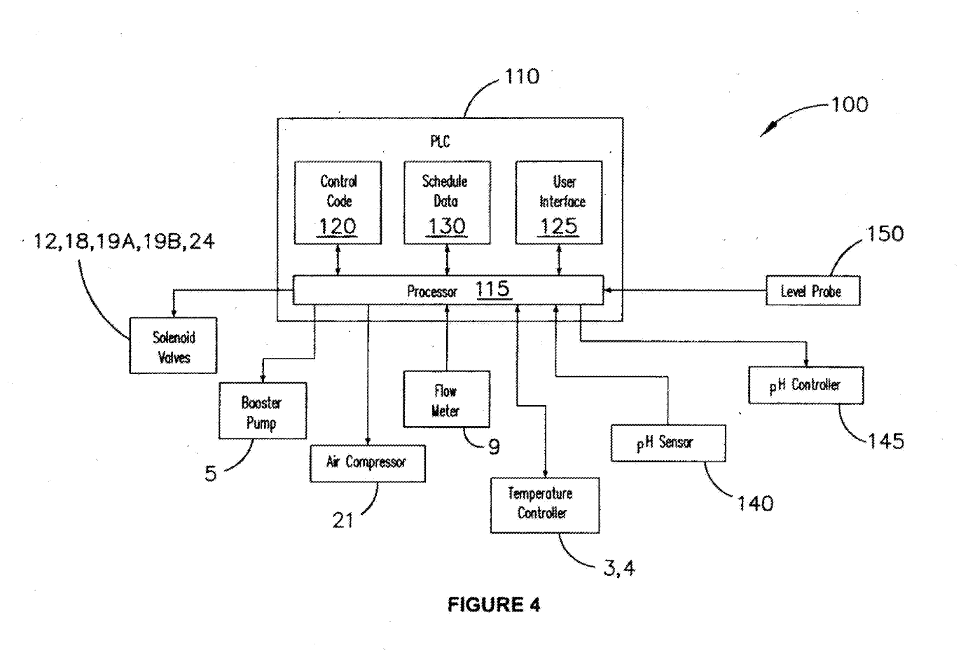

The water recycling apparatus 1 has a permeate (i.e. filtered and treated water) tank 15 connected to the UV disinfection apparatus 11 to store treated water, or permeate. The permeate tank 15 has a level probe 150 (FIG. 4) which relays signals to a processor 115 of a controller 110 for the apparatus 1. The apparatus 1 may be controlled by a programmable logic controller (PLC) 110 which has a touch screen control interface 125, a display (not shown). A PLC is used in this context as just one example of a number of different computing devices that can be configured to control the operation of apparatus 1 as part of control system 100.

The apparatus 1 may have a pH controller 145 which doses permeate supplied from the tank with sulphuric acid (H₂SO₄) to neutralize alkalies in the raw water and maintain the permeate water at a pH of around 7. The pH controller 145 receives signals measured at intervals by a pH sensor probe 140 in the permeate tank 15.

Alternatively the apparatus 1 has provisions for control of pH, temperature adjustment and the adjustment of total dissolved solids (TDS) through applicable mixing valves at any module 51, 52, 53, 54 and 55 or the press 56 of the tunnel washer 50. Therefore providing the flexibility to manipulate the mixture of recycled water and chemicals or fresh water and chemicals at any chamber or module of the continuous batch laundry system 50. This also includes all stages of operation relating to particular modules of the continuous batch laundry system 50. The only modules which are not able to be fed with the recycled water and chemical mixture is the main rinse chamber and sour/starch modules which are fed with fresh or town/city water.

A back-wash solenoid valve 18 connects the exit surfaces of the ceramic membranes in the vessels 7 and 8 to a back-wash tank and pump 20 via suitable fluid conduits 22. Here exit surface refers to the membrane surface which water exits from, or permeates from, when the water is forced through the ceramic membrane in a forward direction. If water is forced from the back-wash tank and pump 20 against the exit surfaces, it will be forced through the ceramic membranes in a reverse direction relative to normal filtering operation. The backwash tank 20 is suitable for pressurizing when solenoid valves 19A and 19B are closed. An air compressor 21 is connected to the back-wash tank 20 to provide compressed air under the control of PLC 110 to pressurise the tank 20.

The back-wash tank and pump 20 is connected to the membrane vessels 7 and 8 by a conduit 22 which is smaller in diameter than the conduit which connects the membrane vessels 7 and 8 to the flow meter 9. For example, the back-wash conduit 22 may be 32 mm in diameter, compared to 50 mm diameter of the permeate conduit. This assists in maintaining back-wash pressure provided by the compressor 21. The backwash tank and pump can be filled with permeate when the solenoid valves 19 are open. This provides a supply of relatively clean water at a temperature which is close enough to the temperature of water in membrane vessels 7 and 8 as to minimize thermal shock to the ceramic membranes in the vessels 7 and 8. The back-wash tank and pump 20 and back-wash piping 22 are configured so that back-wash water forced in a reverse direction through the ceramic membranes differs from the raw water being filtered by the ceramic membranes within a thermal shock tolerance for the ceramic membranes. In this case the thermal shock tolerance may be around 2 to 4 degrees Celsius.

The operation of the embodiment of the recycling apparatus 1 described with reference to FIG. 1 will now be described with the apparatus 100 in a normal mode of operation in which it recycles raw water in the raw water tank 2. The apparatus 1 may be activated by signals at a level probe 150 in the permeate tank 15 indicating to the controller 110 that the permeate levels are low.

Raw water or water drained from pipes and valves 62, 63, 64, 65, 66 from the continuous batch laundry system 50 is transferred via pipe 61, and stored in the raw water tank 2, is heated and maintained at a temperature of 60 degrees by the Direct Steam Injection device 4. The raw water is then drawn from the tank by the booster pump 5 and through hollow ceramic fibre filters in the two ceramic filter vessels 7 and 8 in series at a transmembrane pressure (TMP) of less than 3.0 bar and at a rate at the membrane surface of 2.35 metres per second. Rather than being drawn from the raw water tank 2 transfer pump 30 may re-route the water which has not been filtered sufficiently from the ceramic filter vessels 7 and 8 back through the booster pump 5 to re-filter the raw water. Passing the raw water through the hollow ceramic fibre filter 6 removes particulates and contaminants to a size of greater than 40 nm.

The water (i.e. filtered water, sometime referred to herein as “permeate”) permeated through the hollow ceramic membrane filter 6 passes through the flow meter 9 which monitors the flow rate. In some embodiments signals from the flow meter 9 may be used by the controller 110 to adjust the operation of the booster pump 5. Permeate then passes through a permeate solenoid valve 24 which is open when the apparatus is in this normal operating mode. Permeate then passes through the UV disinfection device 11 which disinfects the permeate water. Next the permeate enters the treated water tank 15. The treated water tank 15 may also include a chlorine dosing pump 31 to further disinfect the permeate.

Treated water or permeate can then be drawn from the treated water tank 15 via conduit 40 and into pipes 41, 42, 43, 44 and 45 associated with modules 51, 52, 53, 54 or directly into entry chute 71 of the continuous batch laundry system 50. Fresh water 48 is also available and used in the final rinse in module 55. The fresh water may also include sour or starch added in the final rinse stages of the wash cycle.

In normal operation, the solenoid valve 18 connecting the backwash tank 20 to the hollow fibre ceramic filter vessels 7, 8 is closed, isolating water in the backwash tank 20 from the filter 6.

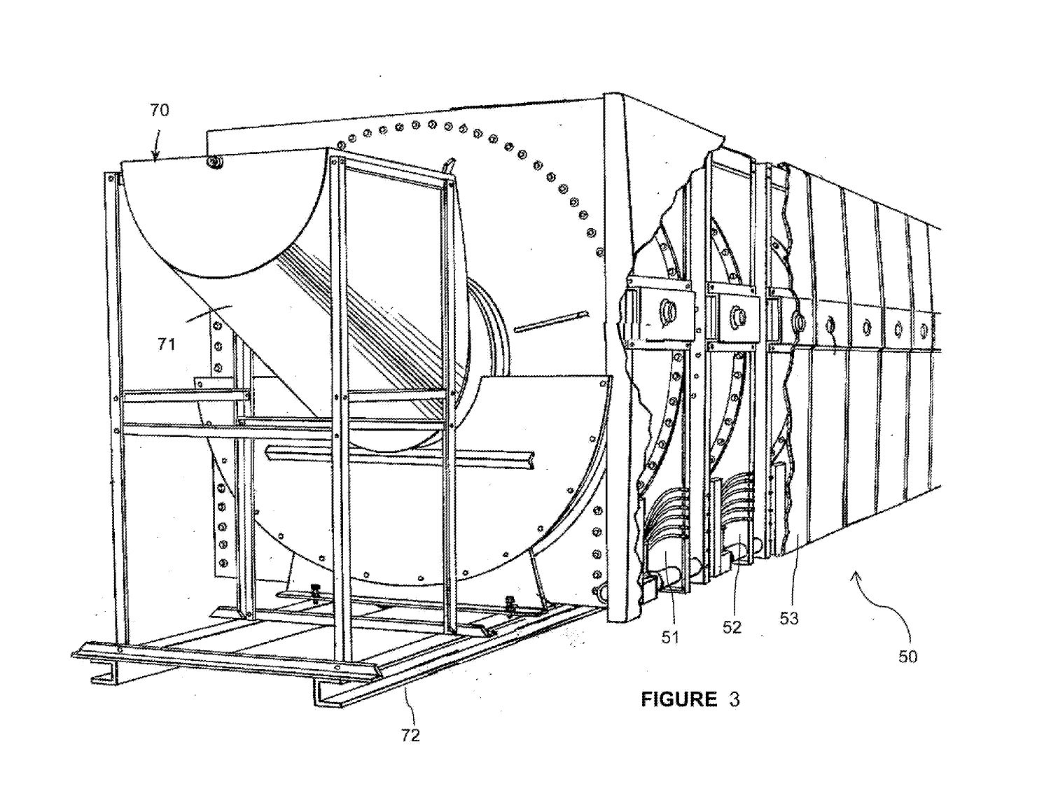

With reference to FIG. 3, there is depicted a perspective view of continuous batch laundry system 50 of the present invention. As can be seen, system 50 includes a plurality of longitudinally aligned modules 51, 52, 53, 54 and 55 each of which houses a rotatably supported drum. Each drum includes two spaced end walls which each include a large opening to provide communication between adjacent drums. Inlet and outlet to each drum is accomplished through a cylindrical sleeve disposed on each end wall. As is typical in such systems, an inlet chute 71 is provided for receiving articles in the chute opening 70 of clothing or the like for laundering and after being fully loaded a load of laundry is present in each of the drums depicted. An outlet chute is provided for the removal of each load of laundry after it has completed its cycle through system 50. The continuous batch laundry system 50 is typically mounted on a frame 72 which supports both the modules 51, 52, 53, 54, 55 and the input chute 71.

Inlet chute 70 can provide a hopper 71 that enables the intake of textiles or fabric articles to be washed. Such fabric articles, textiles, goods to be washed can include clothing, linens, towels, and the like. An extractor (not shown) is positioned next to the outlet end portion of tunnel washer 50. Flow lines 41, 42, 43, 44, 45 are provided for adding water and/or chemicals to tunnel washer 50 at selected or desired locations. Chemicals can also be added to the modules through lines not shown. The chemicals separate the soil from the goods, linens or textiles and suspend the soil in the wash liquor which is able to be drained from the respective modules via valves and conduits 62, 63, 64, 65 and 66.

The water treatment system of the present invention comprises both a continuous batch laundry system 50 and the water treatment apparatus 1. As previously mentioned the continuous batch laundry system 50 or tunnel washer 50 is compactly mounted on a frame 72. In order to not make the footprint of the tunnel washer 50 any larger the water treatment apparatus 1 of the present invention has been designed to conveniently fit within the frame of the tunnel washer 50. Therefore all components of the water treatment apparatus 1 fit within the confines of the outer walls of the tunnel washer 50. Therefore making the water treatment apparatus 1 easy to retrofit to any tunnel washer design.

Alternatively the water treatment apparatus 1 may be an add on unit or stand-alone unit mounted externally of the continuous batch laundry system 50. For example, the water treatment apparatus 1 may be mounted on any side or on top of the continuous batch laundry system 50 and would therefore have connecting hoses or pipes connected to the respective modules of the tunnel washer 50.

FIG. 4 shows a control system 100 having a controller in the exemplary form of PLC 110. The PLC 110 has memory including program code executable by a processor 115 of the PLC 110, where the program code comprises control code 120 to configure the PLC to perform the control functions described herein, schedule data to indicate a maintenance schedule by which the ceramic filter is to undergo its periodic self-cleaning purge, and a user interface module that cooperates with the touch screen (not shown) to provide user interface functionality.

Other embodiments provide a computer readable carrier medium carrying computer executable code, the code operable when executed to configure a configurable device to control a water treatment apparatus 1 to carry out methods desired herein. The configurable device may comprise Programmable Logic-Controller (PLC) 110. The carrier may include a data or information transmission medium such as telephonic transmission media, radio transmission medium, and include data or transmission formats including TCP/IP, telnet, FTP or other transmission formats known to the reader. The carrier medium may include data storage on which is stored the control code 120, user interface 125 and/or maintenance schedule data 130. The storage medium or media may include volatile or non-volatile memory, magnetic or optical media, EEPROM, or any other suitable storage media.

Some embodiments provide a water recycling system which provides high recycling yields for raw or grey water using ceramic membrane filters by heating the raw water to be filtered to take advantage of the applicant's observation that raised temperatures, particularly about 40 degrees Celsius or more, improve the effectiveness of ceramic membrane filters and/or allow these filters to provide effective filtration at more consistent flow rates.

Some embodiments provide efficient operation of recycling for industrial plant by using ceramic membrane filters and heating water to a temperature which balances i) a tendency observed by the applicant for filtering of water by ceramic membrane filters to have a higher efficiency and more consistent operation at higher temperature and ii) energy wastage if the water is heated above a temperature required by the industrial plant.

Some embodiments provide a water recycling system which provides high throughput and/or filter life by providing a reverse flow through the ceramic membrane filters to remove material deposited by the filtration action.

Some embodiments provide grey water recycling using ceramic membrane filters in combination with a vibrating screen filter or media filter.

Some embodiments provide grey water recycling using ceramic membrane filters in combination with a vibrating screen filter and a water heater to control the temperature of water filtered by the ceramic membrane filter to provide improved recycling rates. Other embodiments are adapted from the embodiments described herein to treat water that is not necessarily grey water. Other embodiments are adapted from the embodiments herein to treat liquids other than water.

### Variations

It will be realized that the foregoing has been given by way of illustrative example only and that all other modifications and variations as would be apparent to persons skilled in the art are deemed to fall within the broad scope and ambit of the invention as herein set forth.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

1. A water treatment system comprising:
a continuous batch laundry system comprising a plurality of longitudinally aligned modules having inlet means at one end for receiving articles to be laundered and a discharge means at the other end, each said module including a rotatably supported drum within a housing, said drum being supported for oscillatory and rotary movement about a horizontal axis, wherein each drum includes spaced end walls, each end wall of each drum including a large opening to provide communication between adjacent drums, inlet flow lines on each module to allow chemicals and water into each module and outlet flow lines located on each module for draining each module, and a driving means for inducing rotation and oscillation in at least a selected one of said drums;
a filtering apparatus connected between the outlet flow lines and the inlet flow lines of the continuous batch laundry system to filter and reclaim a mixture of water and chemicals drained from each module the filtering apparatus comprising:
a filter;
a flow apparatus operable to pass the mixture of water and chemicals through the filter in a forward direction so as to filter the water and chemicals;
a heater operatively able to heat the mixture that pass through the filter; and
a temperature controller operatively associated with the heater to control a temperature of the mixture within a preconfigured temperature range;
wherein the filtered and reclaimed mixture of water and chemicals is fed from the filtering apparatus and into the inlet flow lines of each said module of the continuous batch laundry system as required.

2. A water treatment system as claimed in claim 1, wherein the temperature controller is configured to control the temperature of the mixture of water and chemicals between 40 degrees Celsius and 90 degrees Celsius.

3. A water treatment system as claimed in claim 2, wherein the flow apparatus passes water through the filter at a pressure between 1 and 3 bar and at a rate at the filter surface between 1 and 3 metres per second.

4. A water treatment system as claimed in claim 3, wherein the flow apparatus includes a forward-flow apparatus operable to provide the forward-flow and a reverse-flow apparatus operable to provide the reverse flow.

5. A water treatment system as claimed in claim 4, wherein the reverse-flow apparatus includes a backwash pump and tank operable to receive filtered water from the filter to provide water to the reverse-flow apparatus.

6. A water treatment system as claimed in claim 5, wherein the back-wash pump and tank are operable to be pressurised, such that the tank; and a backwash conduit connected to the filter when the backwash tank is pressurised, water from the backwash tank is provided to the filter in the reverse direction.

7. A water treatment system as claimed in claim 6, wherein the filter comprises a media filter or a membrane filter, the membrane filter adapted to provide both microfiltration and ultrafiltration.

8. A water treatment system as claimed in claim 7, wherein the microfiltration or the ultrafiltration filters are used as pre-filters for any one of or combination of:
(i) a nanofiltration filter; or
(ii) a reverse osmosis filter.

9. A water treatment system as claimed in claim 8, wherein the membrane filter comprises any one of or combination of:
(i) a ceramic membrane filter;
(ii) a ceramic hollow fibre membrane filter;
(iii) a channel ceramic membrane filter; or
(iv) a silicon carbide ceramic membrane filter.

10. A water treatment system as claimed in claim 9, further comprising a preliminary filter to filter water prior to it being passed through the membrane filter, the preliminary filter comprising a vibrating membrane.

11. A water treatment system as claimed in claim 10, further comprising a carbon filter downstream of the membrane filter.

12. A water treatment system as claimed in claim 11, further comprising a UV treatment apparatus downstream of the membrane filter to treat water with Ultra Violet light to disinfect the water.

13. A water treatment system as claimed in claim 12, further comprising a pH adjustment apparatus operable to adjust the pH level of filtered water.

14. A water treatment system as claimed in claim 13, wherein the pH level is maintained between 6 and 8.

15. A water treatment system as claimed in claim 14, wherein the continuous batch laundry system is a continuous batch tunnel washer.

16. A process to treat a mixture of water and chemicals including:
providing a continuous batch laundry system comprising a plurality of longitudinally aligned modules;
providing a filtering apparatus to filter and reclaim the mixture of water and chemicals drained from each module;
providing a flow apparatus for passing the mixture through the filter in a forward direction so as to filter the mixture;
providing a heater operatively able to heat the mixture that pass through the filter; and
a temperature controller operatively associated with the heater to control the temperature of the mixture within a preconfigured temperature range prior to passing the mixture through the filter.

17. A process as claimed in claim 16, wherein the process is used to control a water treatment system.

18. A process as claimed in claim 17, wherein the process is controlled by a computer comprising:
a code memory operable to store processor executable code;
a processor operable to execute code stored in the code memory; and
a data memory operable to store data, wherein the code memory stores the code which when executed causes the processor to control the water treatment system.

19. A process for reducing water, chemical and energy consumption in a continuous batch laundry system wherein a mixture of waste water and chemicals is produced as a result of mixing all water from a wash cycle and all water from a rinse cycle of the continuous batch laundry system operating at a predetermined operating wash temperature, comprising the following steps:
(a) processing the mixture of said waste water and chemicals to separate therefrom lint and suspended particles greater than a predetermined size and to produce a corresponding portion of processed water and chemicals;
(b) heating the processed water and chemicals to a predetermined temperature;
(c) passing the heated and processed water and chemicals through a filer;
(d) returning the heated and processed mixture of water and chemicals to the continuous batch laundry system as required;
(e) carrying out said wash cycle of the continuous batch laundry system utilizing said returned mixture of water and chemicals; and
(f) providing unheated fresh water to the washing equipment during a rinsing cycle and/or a starch cycle thereof.

20. A process as claimed in claim 19, wherein the step of filtration is carried out by passing said mixture of said waste water and chemicals through at least one tubular filtration unit.

21. A process as claimed in claim 20, wherein the at least one tubular filtration unit comprises at least one tubular membrane filter capable of retaining particles larger than approximately 5 micron.
